(19) United States
(12) Patent Application Publication
(10) Pub. No.: US 2003/0106262 A1
(43) Pub. Date: Jun. 12, 2003

(54) Ventilation filter for flowerpot

(76) Inventor: Yuan-Song Lai, Taiping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/011,409

(22) Filed: Dec. 11, 2001

(51) Int. Cl. A01G 9/02

(52) U.S. Cl. 47/65.6

(57) ABSTRACT

A perforated ventilation filter installed in a flowerpot to carry soil and plants in the soil, having an upwardly extended corrugated peripheral wall supported on the peripheral wall of the flowerpot and defining with the peripheral wall of the flowerpot a plurality of air passages for circulation of air between the space of inside the ventilation filter and the space outside the ventilation filter.

### BACKGROUND OF THE INVENTION

1. Field of the Invention

The present invention relates to flowerpots and, more particularly, to a ventilation filter for flowerpot, which carries away excessive water from the soil efficiently and, facilitates ventilation of air through the soil in the flowerpot.

2. Description of the Related Art

FIGS. 1A and 1B show a filter 12 installed in a flowerpot 10 to carry soil 1 and plants in the soil 1. The flowerpot 10 has air vents 11 in the bottom wall. The filter 12 is a disk-like member having feet 14 for supporting on the bottom wall of the flowerpot 10 and air vents 13 for drainage of water and ventilation. This design of filter 12 is still not satisfactory in function due to the following drawbacks.

1. Because the soil 1 is maintained in direct contact with the peripheral wall of the flowerpot after installation of the filter 12, less air is allowed to circulate through the soil 1.

2. Because the filter 12 is capable of drawing excessive water from the soil 1 only and does no help to the ventilation of air through the soil 1, it does not attract people to use.

3. Because the soil 1 is maintained in contact with the peripheral wall of the flowerpot 10, the roots of the plant will grasp the peripheral wall of the flowerpot 10, resulting in difficulty of transplanting of the potted plants.

### SUMMARY OF THE INVENTION

The present invention has been accomplished to provide a ventilation filter for flowerpot, which eliminates the aforesaid drawbacks. It is one object of the present invention to provide a ventilation filter for flowerpot, which efficiently carries excessive water from the soil and, facilitates ventilation of air through the soil. It is another object of the present invention to provide a ventilation filter for flowerpot, which enables the soil and potted plants to be conveniently transferred from the flowerpot to another place when desired. According to the present invention, the ventilation filter is perforated, having an upwardly extended corrugated peripheral wall supported on the peripheral wall of the flowerpot and defining with the peripheral wall of the flowerpot a plurality of air passages for circulation of air between the space of inside the ventilation filter and the space outside the ventilation filter. Because the upwardly extended corrugated peripheral wall is supported on the peripheral wall of the flowerpot to prohibit direct contact of the soil carried in the ventilation filter with the peripheral wall of the flowerpot, the user can easily transfer the soil and the potted plants from the flowerpot to another place when desired.

### BRIEF DESCRIPTION OF THE DRAWINGS

FIG. 1A illustrates a ventilation filter for use in flowerpot according to the prior art.

FIG. 1B shows the application of the ventilation filter according to the prior art.

FIG. 2 is a perspective view of a ventilation filter constructed according to the present invention.

FIG. 3A is a front view in section showing the ventilation filter installed in a flowerpot according to the present invention.

FIG. 3B is a top view in section of FIG. 3A.

FIG. 4 is a top view in section showing an alternate form of the ventilation filter installed in a flowerpot according to the present invention.

FIG. 5A is a perspective view of another alternate form of the ventilation filter according to the present invention.

FIG. 5B is a sectional view showing the ventilation filter of FIG. 5A installed in a flowerpot.

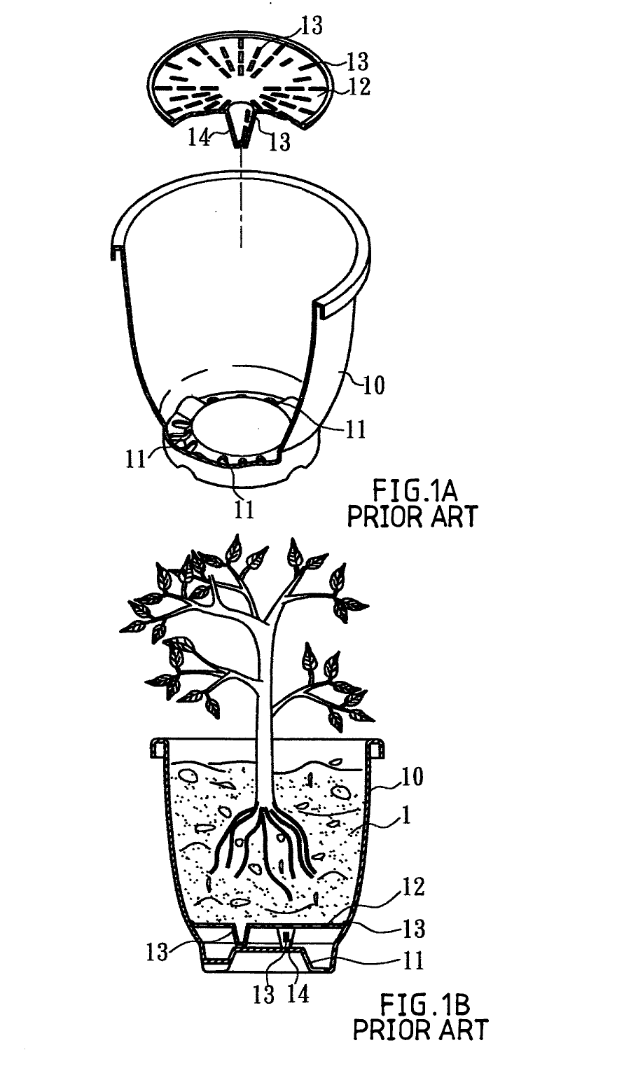

### DETAILED DESCRIPTION OF THE PREFERRED EMBODIMENT

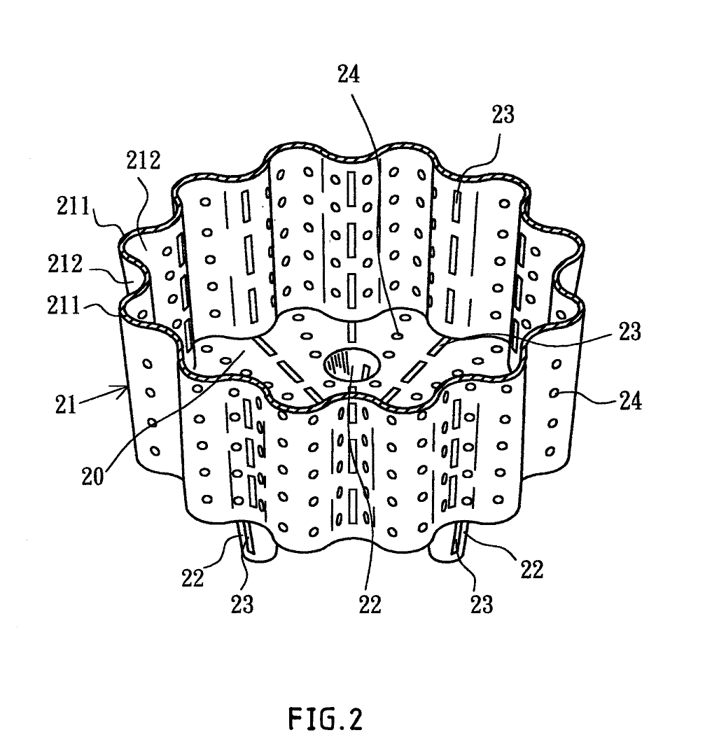

Referring to FIG. 2, a perforated ventilation filter 20 is shown comprising a vertical peripheral wall 21 upwardly extended along the periphery thereof, a plurality of hollow feet 22 downwardly extended from the bottom wall thereof, a plurality of air vents 23 and 24 through the vertical peripheral wall 21, the bottom wall, as well as the hollow feet 22. The vertical peripheral wall 21 is corrugated, having axially extended outwardly curved portions 211 and axially extended inwardly curved portions 212 alternatively arranged around the periphery.

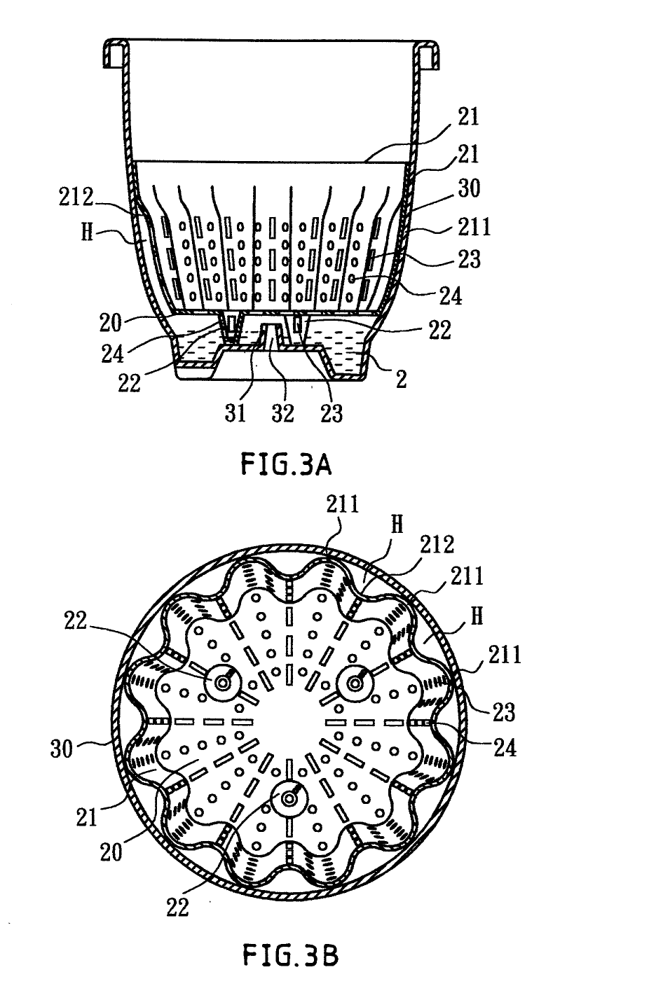

Referring to FIGS. 3A and 3B, after loading in the flowerpot 30, which has a stepped, upwardly protruded bottom wall 31 and an air vent 32 in the center of the stepped, upwardly protruded bottom wall 31, the hollow feet 22 are supported on the stepped, upwardly protruded bottom wall 31 of the flowerpot 30 keeping the bottom wall of the ventilation filter 20 spaced above the topmost edge of the stepped, upwardly protruded bottom wall 31 of the flowerpot 30 at a distance, the axially extended outwardly curved portions 211 of the ventilation filter 20 are disposed in contact with the peripheral wall of the flowerpot 30, and the axially extended inwardly curved portions 212 of the ventilation filter 20 are spaced from the peripheral wall of the flowerpot 30 and define with the peripheral wall of the flowerpot 30 a respective air passage H in communication between the open space above the flowerpot 30 and the inside space of the flowerpot 30 below the ventilation filter 20. Further, the air vents 23 and 24 allow circulation of air through the gaps in the soil carried in the ventilation filter 20, the air passages H, and the air vent 32 of the flowerpot 30. Because the axially extended outwardly curved portions 211 are supported on the peripheral wall of the flowerpot 30 and the hollow feet 22 are supported on the stepped, upwardly protruded bottom wall 31 of the flowerpot 30, the ventilation filter 20 is positively secured to the inside of the flowerpot 30 to support the loaded soil and the plants in the soil. During planting, an excessive amount of water is carried away from the soil in the ventilation filter 20 through the air vents 23 and 24 to the bottom space inside the flowerpot 30. In case the accumulated amount of water in the bottom space of the flowerpot 30 surpasses the elevation of the air vent 32, it flows out of the flowerpot 30 through the air vent 32. Because the air vent 32 is disposed in the topmost edge of the stepped, upwardly protruded bottom wall 31 of the flowerpot 30 below the bottom wall of the ventilation filter 20, a certain amount of water can be accumulated in the bottom space inside the flowerpot, keeping the inside space of the flowerpot 30 in a wet condition.

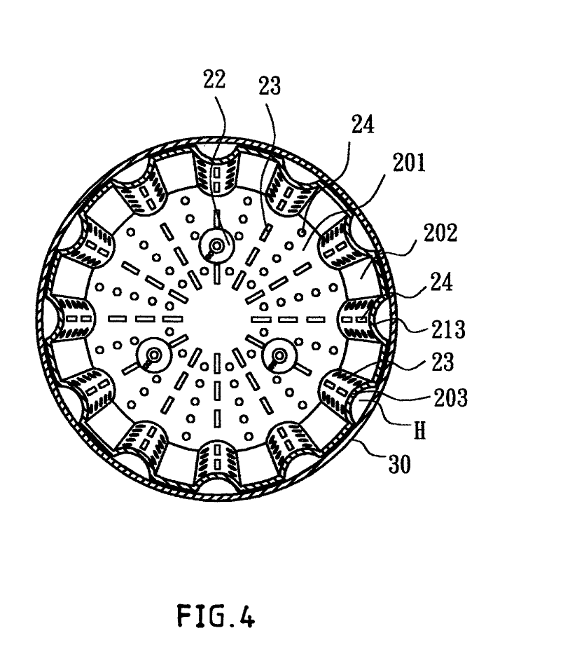

FIG. 4 shows an alternate form of the ventilation filter according to the present invention. According to this embodiment, the peripheral wall 202 of the ventilation filter 201 has equally spaced, axially extended inwardly curved portions 203 of semi-circular cross section. The outer surface 213 of each curved portions 203 defines with the peripheral wall of the flowerpot an axially extended air passage H.

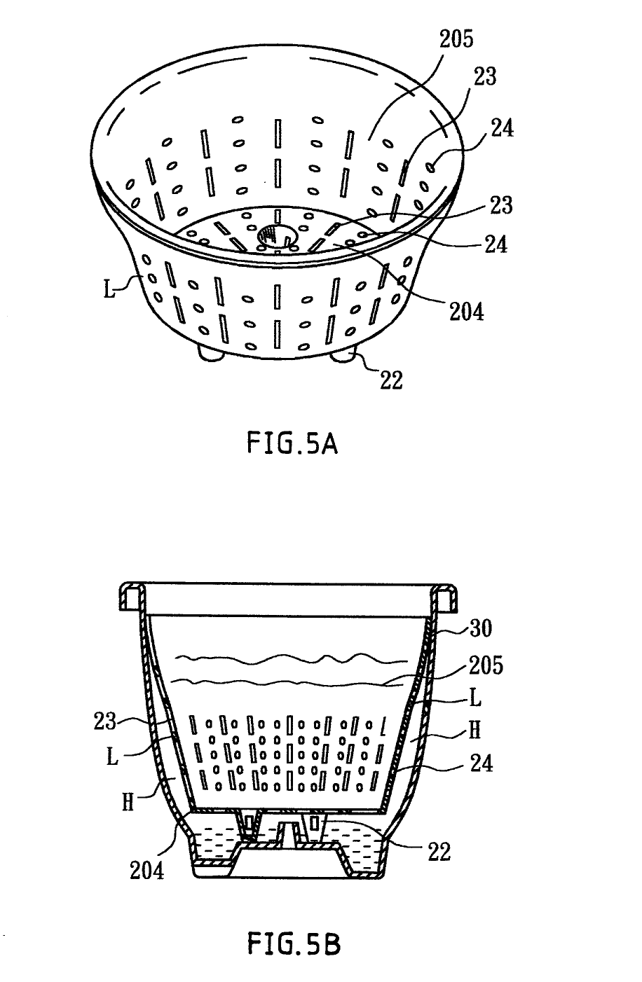

FIGS. 5A and 5B show another alternate form of the ventilation filter according to the present invention. According to this embodiment, the ventilation filter 204 is shaped like a bowl, having an upwardly extended peripheral wall 205. The peripheral wall 205 has a sloping outer face L downwardly inwardly sloping from the top toward the bottom. After installation of the ventilation filter 204 in the flowerpot 30, an air passage H is defined between the peripheral wall 205 of the ventilation filter 204 and the peripheral wall of the flowerpot 30.

Further, the peripheral wall of the ventilation filter can be made having any of a variety of geometric shapes (for example, rectangular or polygonal shape) subject to the shape of the flowerpot to be used.

A prototype of ventilation filter for flowerpot has been constructed with the features of FIGS. 2˜5. The ventilation filter for flowerpot functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A perforated ventilation filter installed in a flowerpot to carry soil and plants in said soil, having an upwardly extended peripheral wall supported on the peripheral wall of said flowerpot and defining with the peripheral wall of said flowerpot at least one air passage for circulation of air between the space of inside said ventilation filter and the space outside said ventilation filter.

2. The perforated ventilation filter as claimed in claim 1, wherein the peripheral wall of said ventilation filter comprises a plurality of axially extended outwardly curved portions supported on the peripheral wall of said flowerpot and a plurality of axially extended inwardly curved portions spaced from the peripheral wall of said flowerpot and defining with the peripheral wall of said flowerpot a respective air passage.

3. The perforated ventilation filter as claimed in claim 2, wherein said axially extended inwardly curved portions each have a semi-circular cross section.

4. The perforated ventilation filter as claimed in claim 1, wherein the peripheral wall of said ventilation filter has an outer surface sloping in one direction from a top side of said ventilation filter toward a bottom side thereof.
